(19) United States
(12) Patent Application Publication
(10) Pub. No.: US 2016/0280516 A1
(43) Pub. Date: Sep. 29, 2016

(54) Portable Landscape Crane

(71) Applicant: Richard Rieger, Bryan, TX (US)

(72) Inventor: Richard Rieger, Bryan, TX (US)

(21) Appl. No.: 14/877,441

(22) Filed: Oct. 7, 2015

Related U.S. Application Data
(60) Provisional application No. 62/063,062, filed on Oct. 13, 2014.

(51) Int. Cl. B66C 19/00; B66D 3/02; B62B 3/02

(52) U.S. Cl. CPC B66C 19/005; B62B 3/02; B66D 3/02

(57) ABSTRACT

A portable landscaping crane device o and system having a U or V shaped frame and wench and cable adapted to be useful for lifting awkward and heavy objects, such as potted trees, boulders, stumps, for pulling Tee post and other similar lifting jobs and for pulling jobs such as fence stretching.

### CROSS REFERENCE TO RELATED APPLICATIONS

This application claims benefit of Provisional Application Ser. No. 62/063,062 filed Oct. 13, 2014, the contents and disclosures of which is incorporated herein by reference in its entirety for all purposes

### BACKGROUND

1. Field of the Invention

The present invention is in the field of portable cranes for lifting and moving heavy, awkward objects such as container trees and boulders.

2. Background

There is a need in the landscaping and tree farm businesses for a portable means to assist in the heavy lifting and pulling. Planting container trees and doing small landscaping jobs involves heavy lifting, frequently requires several people since it is difficult for a single person to manage. The lifting frequently results in back injuries.

The landscaping crane of the present invention makes it possible to more easily plant trees and accomplish other landscaping jobs. With the landscaping crane, the user can easily install a tree up to the size of a 90 gallon container including lifting the tree from a trailer or truck, stabilizing the tree in an upright position and carting the tree across an area without disturbing the ground. Moreover the device of this invention is useful for lifting any awkward and heavy objects, such as boulders, stumps, pulling Tee post and other similar lifting jobs and for pulling jobs such as fence stretching.

### SUMMARY

The present invention is a landscaping crane device useful for lifting potter trees, boulders and as an aid in tree transplanting and to remove existing trees from the ground. It can also be used to remove existing t-post and for assisted pulling.

### DESCRIPTION OF THE FIGURES

FIG. 1 is a perspective view of an embodiment of the invention.

FIG. 2 is a perspective view of an embodiment of the invention.

FIG. 3 is a perspective view of an embodiment of the invention showing more detail of the pulley system.

FIG. 4 is a perspective view of an embodiment of the invention showing more details of a lift brace.

FIG. 5 is a perspective view of an embodiment of the invention showing more details of a lift brace.

FIGS. 6A, 6B, 6C and 6D are views of drawings of an embodiment of the invention.

FIG. 7 is a perspective view of a tee post puller of an embodiment of the invention showing the puller around a tee post.

FIG. 8 is a perspective view of a tee post puller of an embodiment of the invention.

FIG. 9 is a perspective view of an embodiment of the invention showing an arrangement for pulling.

FIG. 10 is also a perspective view showing the arrangement for pulling.

### DETAILED DESCRIPTION

In broad aspect is a crane device that includes a U-shaped or V-shaped frame, a crank, a pulley system and a handle, optionally mounted on wheels. A hook is attached to the end of a cable on the pulley system. The frame is designed to cradle objects, connect and lift and/or lower movable loads and in some embodiment can assist in pulling posts and stretching wire (such as fencing).

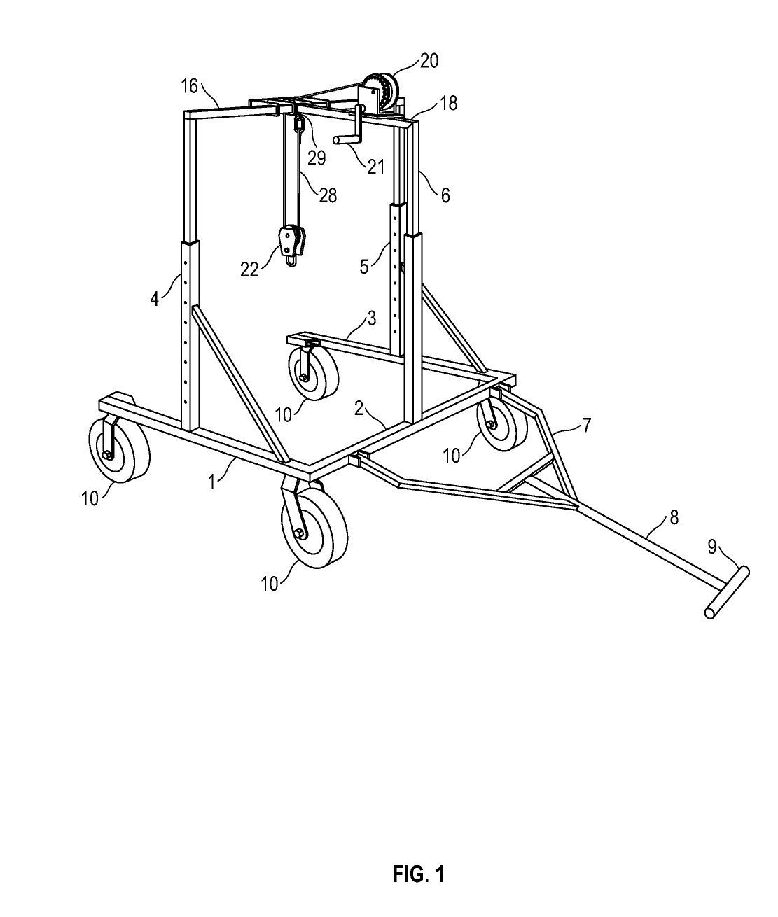

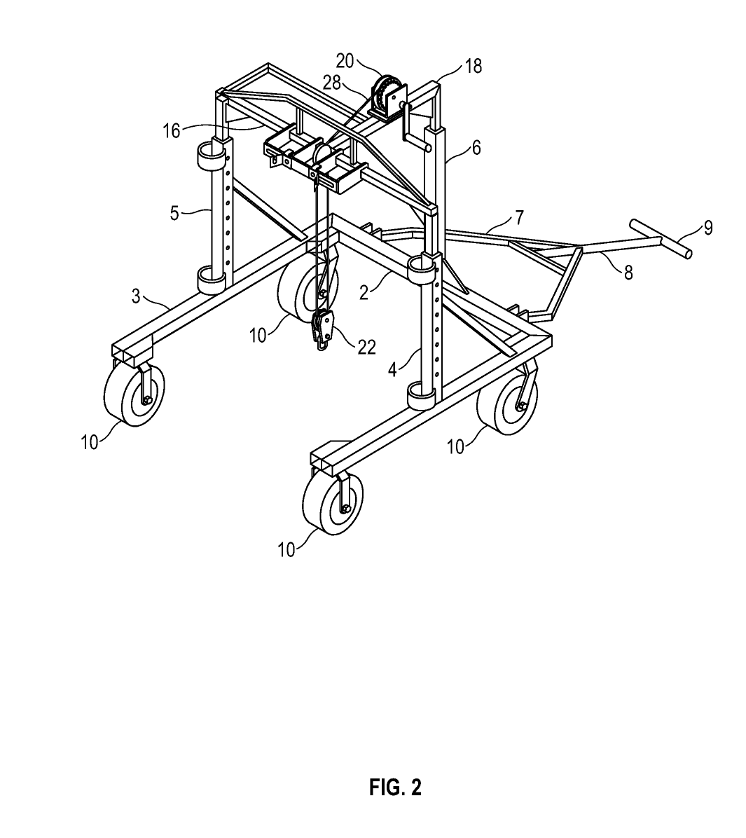

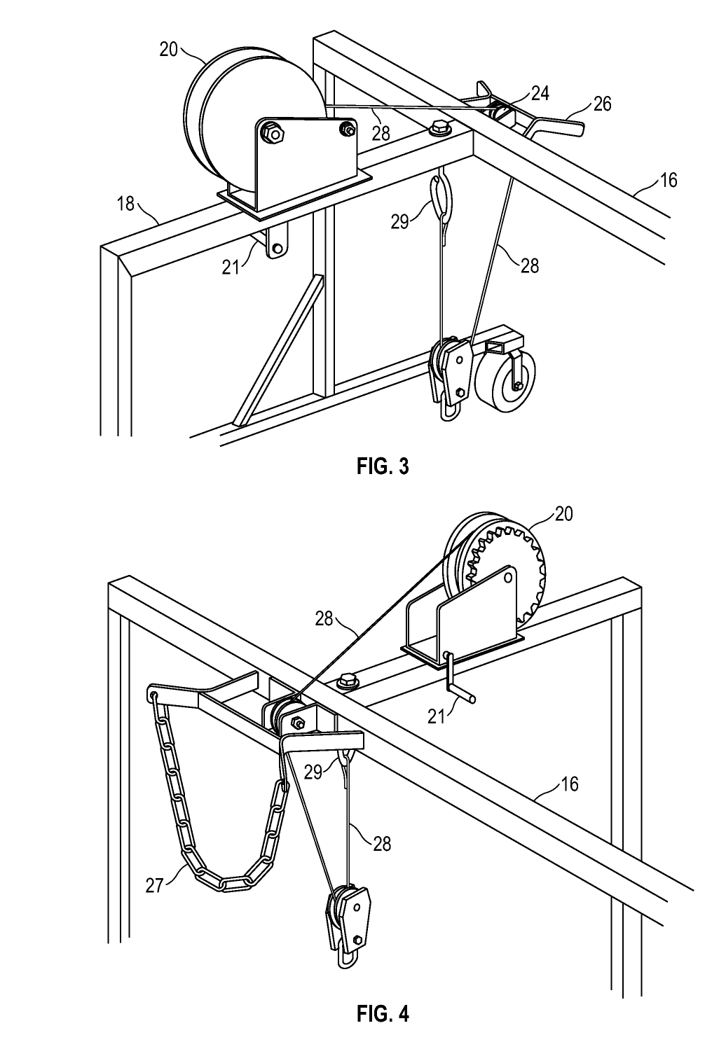

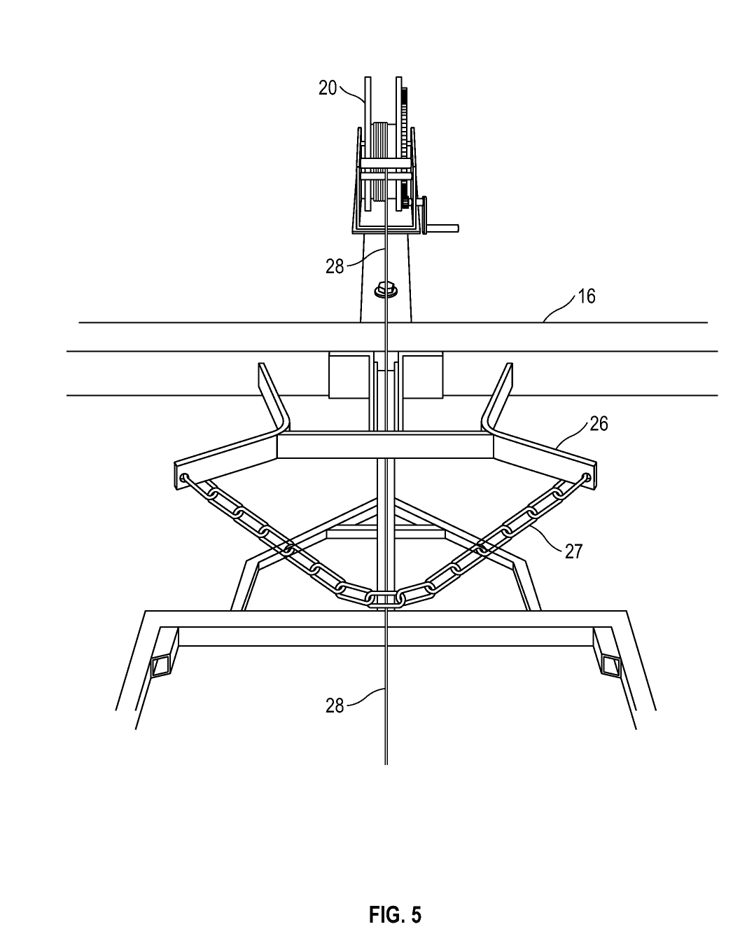

A prototype of an embodiment of the invention illustrates the invention but is not intended to limit its scope. Drawing of a prototype is illustrated in the Figures. Referring to FIGS. 1 and 2, there is a support frame consisting of square steel rods 1, 2 and 3 welded together to form a U-shape in the plane of the ground. Alternatively member 2 could be eliminated and member 1 and 3 formed into a V configuration with a similar opening as in the U-shape. Members 1, 2 and 3 can also be made of one metal bar bent into a U or V shape. The length of members 1, 2 and 3 will be sufficient to allow the support frame to be placed around an object to be raised, such as potted tree for planting or a boulder and the like. In general, the structure of the crane will be about 3 to 5 feet in length. Optional wheels, 10, are disposed on the underside corners of the support frame. The wheels have an axle member and are attached to the support frame. The wheels may be any suitable size but should be large enough to support the device in use and be easily moved. Wheels of 4 to 12 inch diameter are suitable with a diameter of 6 to 8 inches preferred. Upright member 4, 5 and 6 extend upward from the support frame members spaced about midway the support member length. Cross member 16 spans across from member 4 and 6. This cross member, 16, provides support for lifting and has disposed upon it, facing toward the open side of the support frame, a pulley system, 24 (FIGS. 3, 4 and 5). Connected to the front of the support frame is a handle connector 7 and handle bar 8 with handle 9. A second cross member 18 connects cross member 16 with leg 5. Items 7, 8 and 9 comprise the handle system and are used to pull the device from place to place. A wench, 20, and pully 22 are also shown. The arrangement shown is only one means to maneuver the device and those skilled in the art will able to devise other suitable designs.

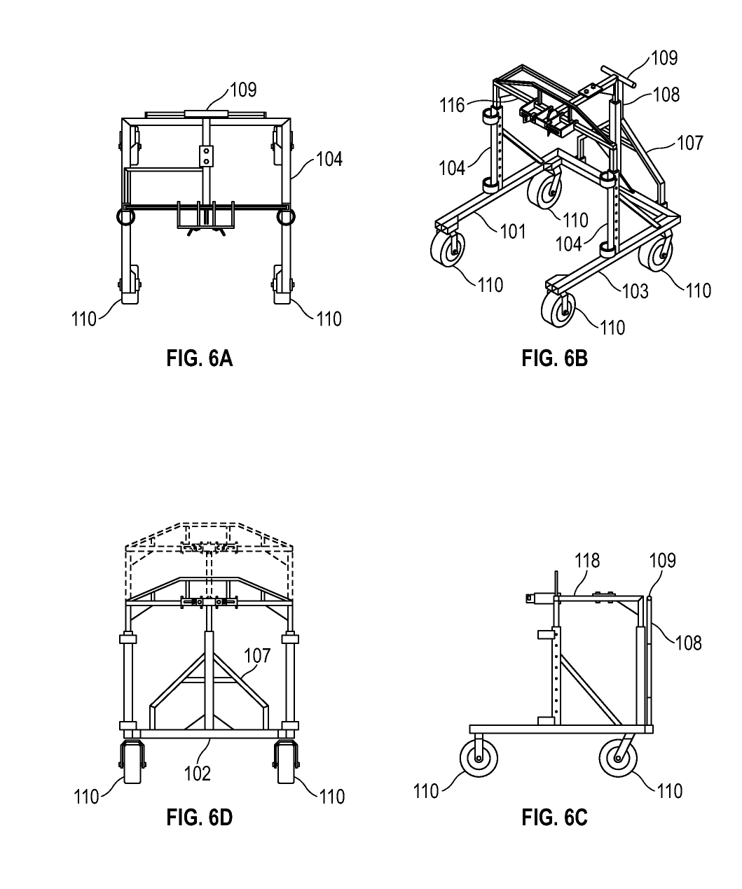

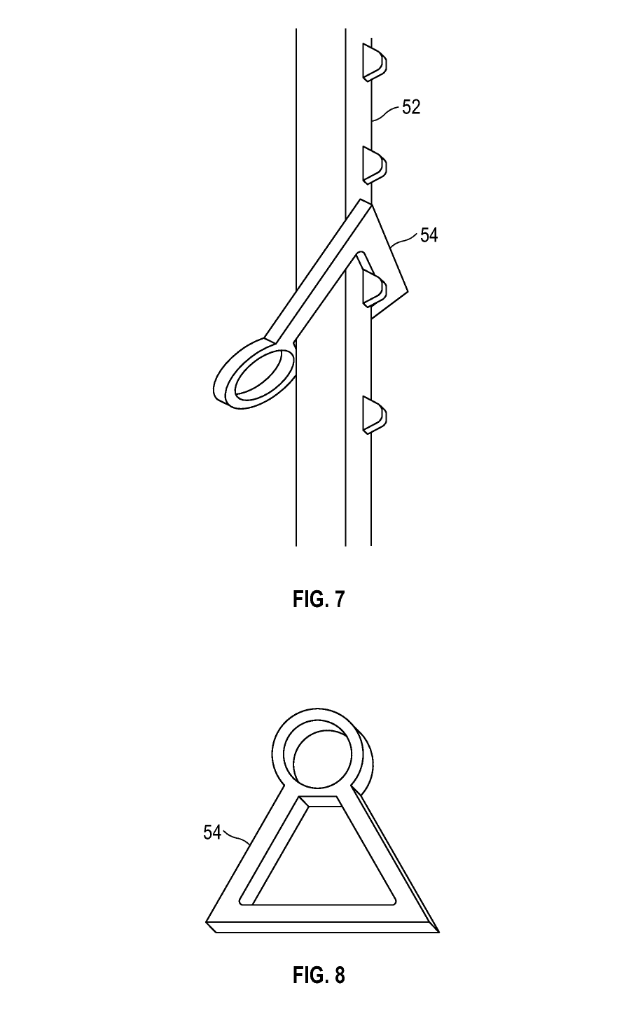

As shown more clearly in FIG. 2-4 there is a winch system 20 with crank 21 mounted on member 18. The winch system as shown wraps a cable, 28, around a mandrel of the winch. The cable is prevented from releasing by a ratchets system as is common for such winch systems. An electric winch system may also be advantageously used. It may be supplied by electric cord connected to an electrical supply but more conveniently will be powered by a battery (such as an automobile battery) mounted on the device. Attached to the cross member 16 is a pulley, 24, and a brace, 26, to support the object to be object to be lifted (see especially FIGS. 3, 4 and 5). The brace, 26, is most useful for lifting potted trees or other objects that have substantial vertical height. A chain 27 is shown that can be used to secure the vertical portion of the lifted object. Chains, belts, ropes, or other securing means are also suitable for securing items. The cable passes over the pulley 24 and around a second pulley and hook 22. The end of the cable, 28, is attached to the cross member by a pulley/hook 22. The pulley cable is suspended on one end to hook 29. Flexible fabric support means can be attached to the hook, 22, to provide support for the object being lifted. These features are shown in more detail in FIGS. 3-5. FIG. 6 A-D are drawings of embodiments of the invention. The frame consists of members 101,102,103, 104, 116 and 118. Wheels 110 are mounted on the bottom corners. The handle system comprises 107, 108 and 109. This embodiment is essentially the same as described above.

The crane device may be used with nylon (or other suitable fabric materials) slings of varying lengths, depending on the task. Lifting boulders require longer slings and lifting planted trees require shorter slings. To remove tee post, a ring is dropped around the tee post and hooked to the pulley system. FIGS. 7 and 8 illustrate a very suitable pulling ring, 54, that is a component part of an embodiment of the invention. The V shape portion fits snugly around a tee post, 52, and when angled the flat portion fits under one of the protrusions of the post. This device is much easier and safer to use than a chain wrap that is customarily used.

### Operation and Use

The device of the invention is especially useful in replanting potted (tree in a container) growing trees. In the tree farm business, tree farmers raising container trees, grow trees in a container until the tree outgrows the container. The tree is then removed from the container and placed into a larger container. This is usually done by hand and takes several people to lay the tree over on its side, pull the tree from the container and pick the tree up into the larger container. With the crane device of the invention, the tree is lifted to a height that will allow the larger container to slide under the tree base. The smaller container can be removed without having to handle the tree and the root ball is lower into the larger container.

For transplanting a potted tree the crane device of the invention is able to straddle a hole prepared for the tree and lower the tree into the hole. The device is able to keep the tree straight and stable until the hole is filled with soil. Once the tree is stabilized by the soil, the tree is disconnected from the device. The device is then maneuvered from around the tree. The tree is normally then stabilized with tee post and wire. The device of the invention will, optionally, also transport the tee post and wire and any other necessary tools needed to complete a planting job. Landscaping companies normally warranty their trees for a certain amount time. In cases where the tree dies in the ground, the company will remove the tree and tee post and replace them. The crane device of the invention is advantageously used to remove the tree from the ground and also remove the tee post (for example, by using the device of FIGS. 7 and 8). The landscaping crane may also be used for removing fence post such as those used on privacy or pasture fences.

A prototype crane device of the invention has been demonstrated by using it to load boulders weighing up to 1000 pounds onto a trailer and also used to offload the boulders and delicately place the boulder in beds of existing lawns, not disturbing things like sprinkler heads or existing bedding. A job like moving the boulders customarily requires large equipment such as a skid steer loader which creates ruts and damage to existing lawns.

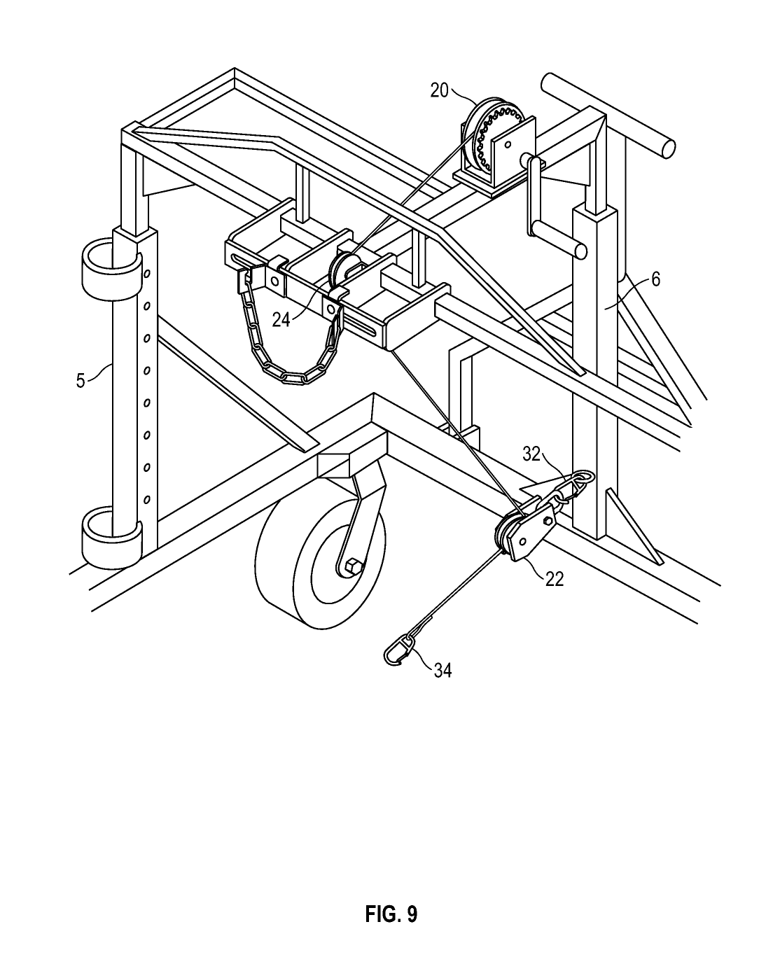

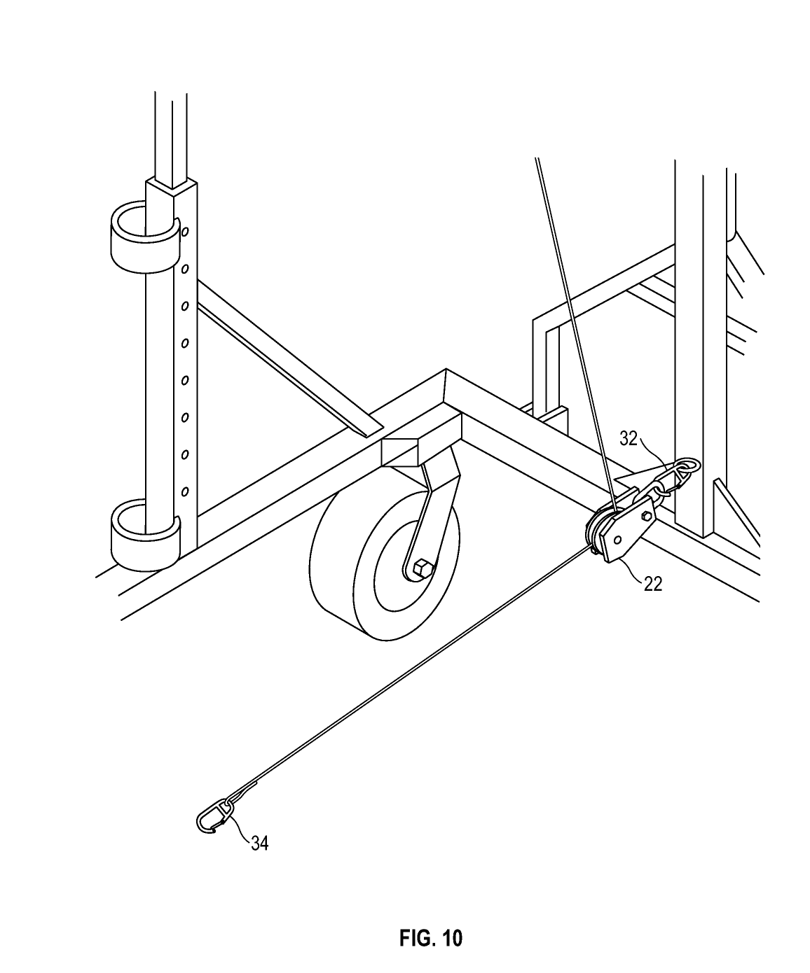

The crane of the invention is also adaptable for use in horizontal pulling, such as to stretch wire fence. FIGS. 9 and 10 show an embodiment of the crane adapted with connector 32 to connect pulley 22 at the lower section of the frame. Cable 28 is fed through pulley connected to the frame 31 to configure it for horizontal pulling. Connector 34 allows the cable 28 to be attached to an object to be pulled. This configuration allows the user can stretch wire fence by chocking the crane against a post and connecting the hook to the wire fence. Another use is pulling heavy objects to the rear of a trailer such as landscape boulders and trees, etc.

In the foregoing specification, the invention has been described with reference to specific embodiments. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. A crane device comprising:
a support frame having one side open;
vertical members attached to the top side of the support frame;
a first cross member attached to vertical members;
a second cross member attached to vertical members;
a winch disposed on the first cross member having a cable attached at one end to a mandrel on the winch;
a first pulley system attached to the second cross member through which the cable extends;
a second pulley system with a hook attached to the cable; and
a means to secure one end of the cable to the second cross member.

2. The crane device of claim 1 comprising wheels attached to the underside of the support frame.

3. The crane device of claim 1 also comprising a handle system for maneuvering the device.

4. The crane device of claim 1 wherein the winch is electric powered.

5. The crane device of claim 1 wherein the frame bottom comprises three or four members configured into a V or U configuration respectively.

6. The crane device of claim 1 also comprising a tee post puller.

7. The crane device also comprising a connection on the lower frame member to which is attached a pulley to facilitate horizontal pulling.

8. A portable crane system comprising;
a) a device comprising:
a support frame having one side open;
vertical members attached to the top side of the support frame;
a first cross member attached to vertical members;
a second cross member attached to vertical members;
a winch disposed on the first cross member;
a first pulley system attached to the second cross member through which the cable extends;
a second pulley system with a hook attached to the cable; and
a means to secure one end of the cable to the second cross member;
b) a cable attached at one end to a mandrel on the winch cable; and
c) hooks attached to the end of the cable.

9. The system of claim 8 wherein the wench is electric powered.

10. The system of claim 9 wherein the wench is electric powered by a battery carried on the device.
